(19) United States
(12) Patent Application Publication
(10) Pub. No.: US 2016/0317956 A1
(43) Pub. Date: Nov. 3, 2016

(54) COMBINATION MANIFOLD FOR A MACHINE

(71) Applicant: Caterpillar Global Mining LLC, Oak Creek, WI (US)

(72) Inventor: Michael Schneider, Wertheim (DE)

(73) Assignee: Caterpillar Global Mining LLC, Oak Creek, WI (US)

(21) Appl. No.: 14/702,142

(22) Filed: May 1, 2015

(51) Int. Cl. B01D 35/02

(52) U.S. Cl. CPC B01D 35/02

(57) ABSTRACT

A combination manifold for selectively driving at least one hydraulic circuit of a machine includes at least one filter module that is configured to fluidly connect with at least one pump of the machine. The combination manifold further includes at least one junction module that is selectively coupled with at least a pair of adjacently located filter modules on the basis of the machine having a plurality of the pumps and the machine correspondingly employing a plurality of the filter modules. The combination manifold further includes at least one valve module that is selectively coupled to at least one of: the junction module and the filter module on the basis of the machine having at least a pair of hydraulic circuits therein.

### TECHNICAL FIELD

The present disclosure relates to a fluid manifold for a machine, and more particularly, to a combination manifold that can be configured for use across various types of machines.

### BACKGROUND

Typically, machines having hydraulic circuits may employ fluid manifolds to perform functions such as, but not limited to, filtration of a fluid, relieving of pressure associated with the fluid, and shunting of the fluid between two or more fluid lines of the hydraulic circuit. Depending on a type of the machine, a manufacturer may produce a fluid manifold that is configured to suit a layout of the hydraulic circuit in the machine. However, differences in layouts of hydraulic circuits across various types of machines may entail the manufacturer to produce unique configurations of the fluid manifold. Such unique configurations for different machines may incur additional time, costs, and effort associated with manufacturing of the fluid manifolds.

Hence, there is a need for a manifold that can be configured for implementation in various types of machines to suit a hydraulic layout of the given machine. Further, there is a need for a manifold that can help manufacturers reduce costs, time, and effort previously incurred in the manufacture of numerous unique configurations of fluid manifolds.

### SUMMARY OF THE DISCLOSURE

In one aspect of the present disclosure, a combination manifold for selectively driving at least one hydraulic circuit of a machine includes at least one filter module that is configured to fluidly connect with at least one pump of the machine. The combination manifold further includes at least one junction module that is selectively coupled with at least a pair of adjacently located filter modules on the basis of the machine having a plurality of the pumps and the machine correspondingly employing a plurality of the filter modules. The combination manifold further includes at least one valve module that is selectively coupled to at least one of: the junction module and the filter module on the basis of the machine having at least a pair of hydraulic circuits therein.

In another aspect of the present disclosure, a combination manifold for selectively driving at least one hydraulic circuit in a machine includes a filter module having a first inlet port, a filter element, a check valve, and a relief valve. The filter element is disposed in fluid communication with the first inlet port. The check valve is disposed in fluid communication with the filter element and configured to open at a first pressure value such that the first inlet port is allowed to be in fluid communication with a first outlet port. The relief valve is fluidly coupled to the filter element and disposed parallel to the check valve. The relief valve is configured to open at a second pressure value that is greater than the first pressure value.

In yet another aspect of the present disclosure, a method of using a combination manifold for a machine having at least one pump and at least one hydraulic circuit therein is provided. The method includes providing at least one filter module, at least one junction module, and at least one valve module, wherein each of the filter modules, the junction modules, and the valve modules is formed to be of a structurally modular construction to allow selective coupling with one another. The method further includes using the filter module alone by coupling the at least one filter module between the pump and the hydraulic circuit on the basis of the machine having only one hydraulic circuit. The method further includes selectively coupling the at least one junction module to a pair of adjacently located filter modules on the basis of the machine having a plurality of pumps, and a plurality of the filter modules being correspondingly coupled to the plurality of pumps. The method further includes selectively coupling the valve module to at least one of: the junction module and the filter module on the basis of the machine having at least a pair of hydraulic circuits therein.

Other features and aspects of this disclosure will be apparent from the following description and the accompanying drawings.

### BRIEF DESCRIPTION OF THE DRAWINGS

FIG. 1 is a side view of an exemplary machine in which embodiments of the present disclosure can be implemented;

FIG. 2 is a schematic view of a filter module, in accordance with embodiment of the present disclosure;

FIG. 3 is a schematic view of a junction module, in accordance with an embodiment of the present disclosure;

FIG. 4 is a schematic view of a valve module, in accordance with an embodiment of the present disclosure;

FIG. 5 is a schematic view of a combination module configured using a pair of filter modules, in accordance with an embodiment of the present disclosure;

FIG. 6 is a schematic view of a combination module configured using four filter modules, in accordance with another embodiment of the present disclosure;

FIG. 7 is a schematic view of a combination module configured using six filter modules, in accordance with another embodiment of the present disclosure;

FIG. 8 is a schematic view of a combination module configured using a pair of filter modules and one junction module, in accordance with another embodiment of the present disclosure;

FIG. 9 is a schematic view of a combination module configured using eight filter modules and four junction modules, in accordance with another embodiment of the present disclosure;

FIG. 10 is a schematic view of a combination module configured using four filter modules, two junction modules, and two valve modules, in accordance with another embodiment of the present disclosure;

FIG. 11 is a schematic view of a combination module configured using eight filter modules, four junction modules, and four valve modules, in accordance with another embodiment of the present disclosure;

FIG. 12 is a flowchart showing a method of using the combination manifold, pursuant to various embodiments of the present disclosure; and

FIG. 13 is a schematic view of a combination module configured using two filter modules and two valve modules, in accordance with another embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

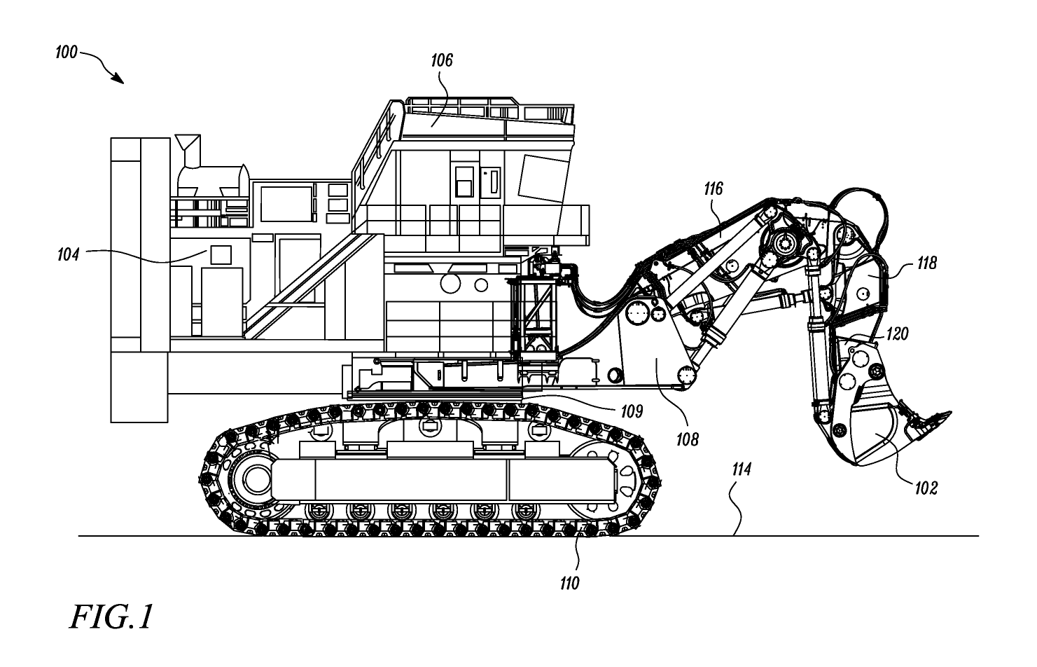

FIG. 1 shows a perspective view of an exemplary machine 100 in which embodiments of the present disclosure can be implemented. The machine 100, disclosed herein, is a mining shovel embodied in form of a tracked vehicle having an excavating bucket 102. More specifically, a configuration of the mining shovel illustrated in FIG. 1 is that of a face shovel configuration. However, a mining shovel having a backhoe configuration can alternatively be used to implement the embodiments of the present disclosure. Moreover, although embodiments of the present disclosure are disclosed in conjunction with a mining shovel, it will be appreciated that systems and methods disclosed herein can be similarly applied to other types of machines known in the art without deviating from the spirit of the present disclosure.

The machine 100 further includes a prime mover 104 and a cab 106 that are rigidly mounted on a frame 108. The cab 106 is provided to house an operator of the machine 100. Moreover, the cab 106 includes control implements (not shown) that are operable for controlling a working of the machine 100.

The prime mover 104 may be a fuel-based engine that powers the machine 100 by combustion of natural resources, such as gasoline, liquid natural gas, or other petroleum products. However, in alternative embodiments, the present disclosure may be equally implemented by way of using an electric motor in lieu of the engine, or a hybrid system that allows use of an engine and an electric motor for performing functions associated with the machine 100.

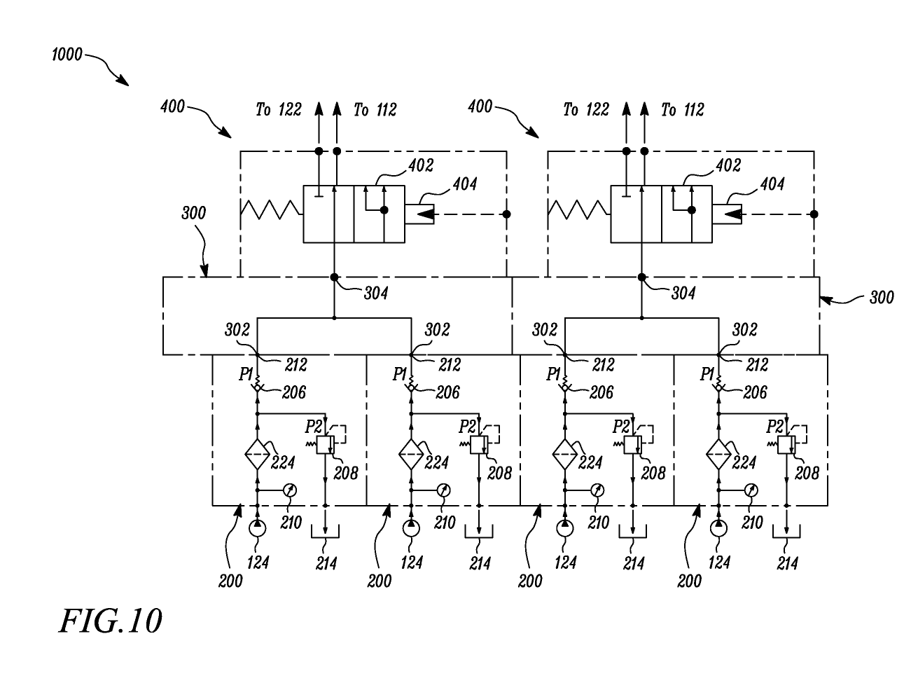

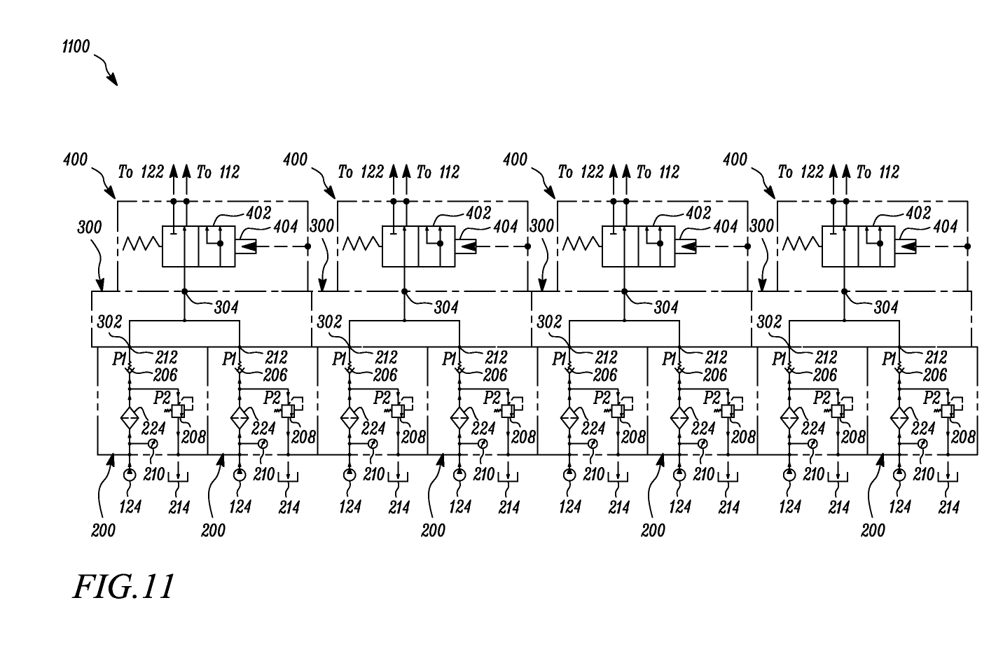

Moreover, as shown, the machine 100 includes a carbody 109 that rotatably supports the frame 108 thereon. Further, the machine 100 also includes a pair of tracks 110 that are rotatably mounted on either side of the carbody 109 (only one track 110 visible in the side view of FIG. 1). Additionally, the machine 100 may include a drive circuit 112 (shown in FIGS. 10-11) that is communicably coupled to the pair of tracks 110. This drive circuit 112 may be configured to rotatably drive the tracks 110 in relation to the carbody 109 and hence, propel the machine 100 on a ground surface 114. For purposes of the present disclosure, the drive circuit 112 may be regarded as ‘the first hydraulic circuit’ and designated with the same numeral ‘112’.

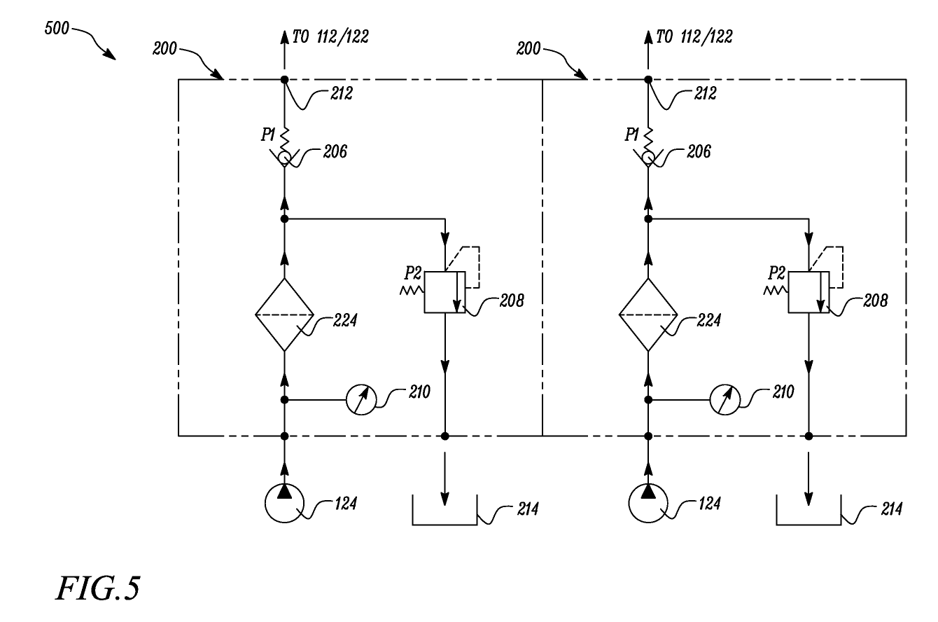

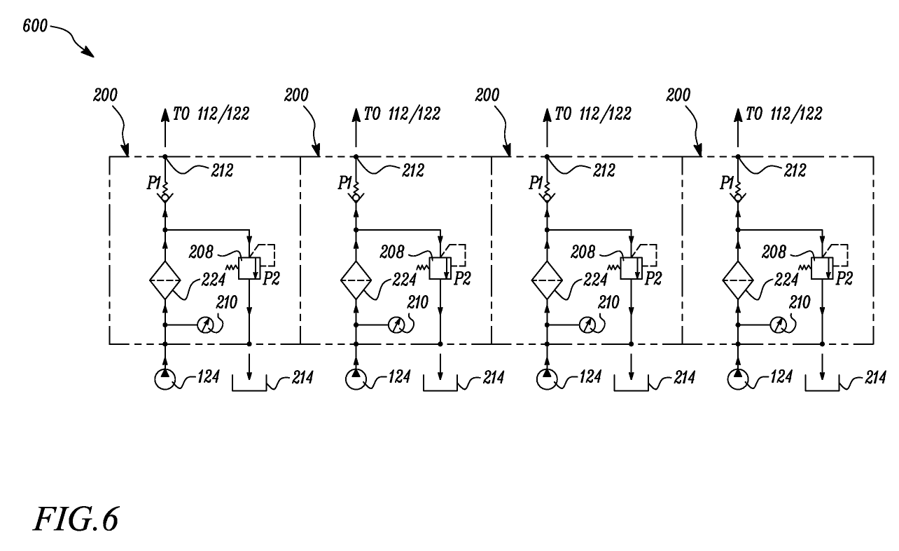

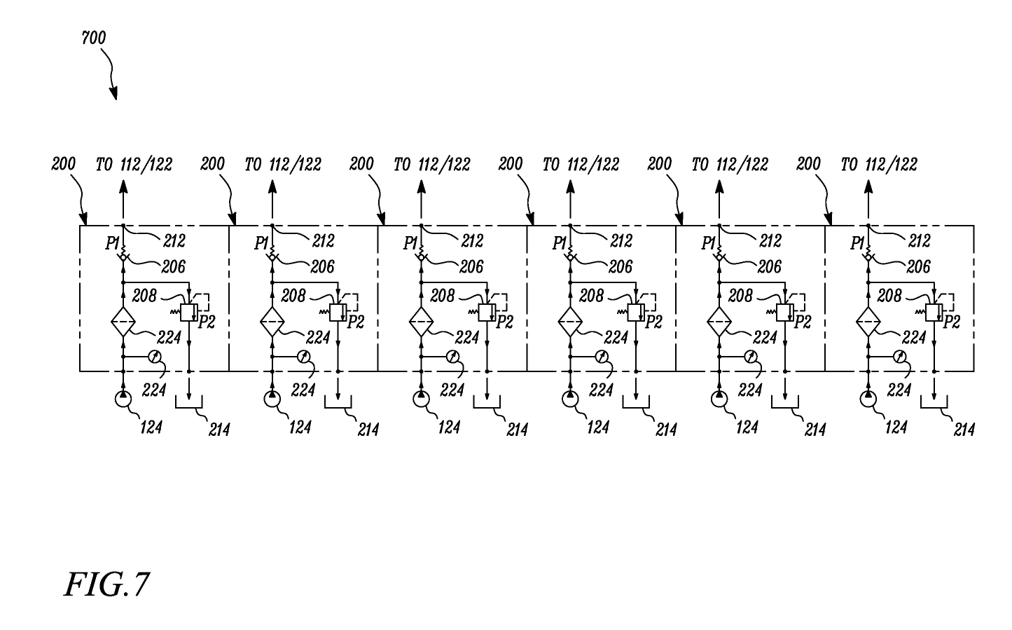

Further, as shown in FIG. 1, the machine 100 may include a boom 116, and a stick 118 that are pivotally coupled in sequence to the frame 108. A distal end 120 of the stick 118 is also coupled to the bucket 102 of the machine 100. The boom 116 and the stick 118 can be configured to impart dexterity to the bucket 102 for executing operations such as loading and/or unloading of material from a work site (not shown). As such, the machine 100 may further include a work attachment circuit 122 (shown in FIGS. 5-11) that is configured to drive hydraulics associated with the stick 118 and the boom 116. The work attachment circuit 122 can therefore, cause movement of the stick 118 and the boom 116 and hence, facilitate an articulation of the bucket 102 relative to the frame 108. For the purposes of the present disclosure, the work attachment circuit 122 may be regarded as ‘the second hydraulic circuit’ and designated with the same numeral ‘122’.

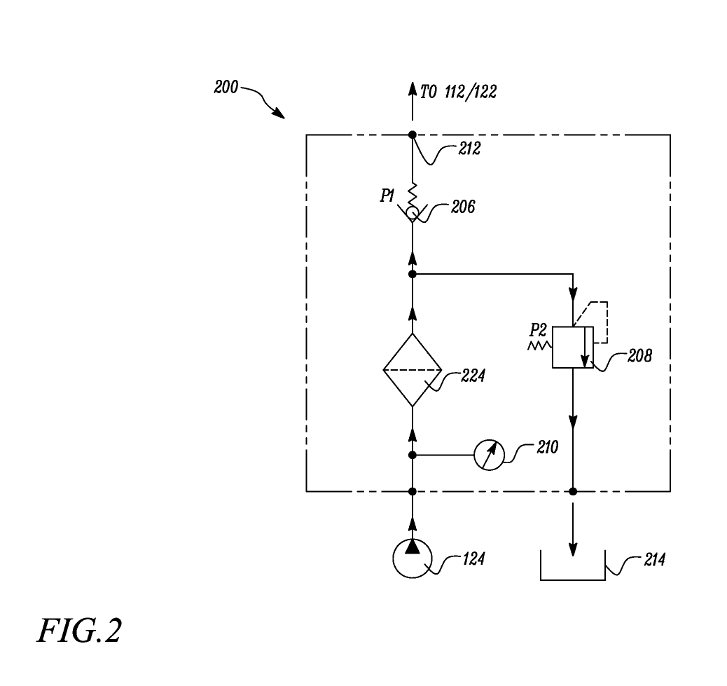

In various embodiments of the present disclosure, the machine 100 further includes one or more pumps 124 (shown in FIGS. 2, 5-11, and 13) that are configured to selectively provide a supply of pressurized fluid to the first hydraulic circuit 112 and the second hydraulic circuit 122 so that the tracks 110 and the bucket 102 can execute movements consistent with an operating procedure of the machine 100 on the work site. The pressurized fluid may be for e.g., a particular grade of oil that is selected to suit specific requirements of an application. As known to one skilled in the art, in some cases, hydraulic mining shovels typically include several pumps 124 that are classified based on their function and/or location on the machine 100 respectively. In most of the cases, pumps 124 on a mining shovel are categorically classified as right-hand pumps (R.H pumps) 124a and left-hand pumps (L.H pumps) 124b depending on whether a given pump 124 is located on a right portion of the machine 100 or a left portion of the machine 100 respectively. These R.H and L.H pumps 124a and 124b may be configured to selectively supply pressurized fluid to each of the first hydraulic circuit 112 and the second hydraulic circuit 122 respectively depending on various requirements of an application.

The present disclosure relates to a combination manifold 500, 600, 700, 800, 900, 1000, 1100, and 1300 that can be used to drive at least one hydraulic circuit i.e., first hydraulic circuit 112 and/or second hydraulic circuit 122 of the machine 100. Explanation to various configurations of the combination manifold 500, 600, 700, 800, 900, 1000, 1100, and 1300 as shown in FIGS. 5-11 and 13 will hereinafter be made in conjunction with FIGS. 1-11 and 13. It should be noted that although some configurations of the combination manifolds 500, 600, 700, 800, 900, 1000, 1100, and 1300 have been disclosed in conjunction with FIGS. 5-11 and 13, other configurations can be additionally contemplated by one of ordinary skill in the art depending on specific requirements of an application and without deviating from the spirit of the present disclosure.

A combination manifold 500, 600, 700, 800, 900, 1000, 1100, and 1300 of the present disclosure, embodiments of which are disclosed in FIGS. 5-11 and 13, each include at least one filter module 200 of a type and configuration disclosed in FIG. 2. Referring to FIGS. 2 and 5-11, the filter module 200 is configured to fluidly connect with at least one pump 124 of the machine 100. The filter module 200 may connect with a R.H pump 124a or a L.H pump 124b depending on specific requirements of an application. However, it may be noted that the embodiments of the present disclosure can be realized by coupling the filter module 200 to the pump 124 regardless of whether the pump 124 is a L.H. pump 124b or a R.H. pump 124a

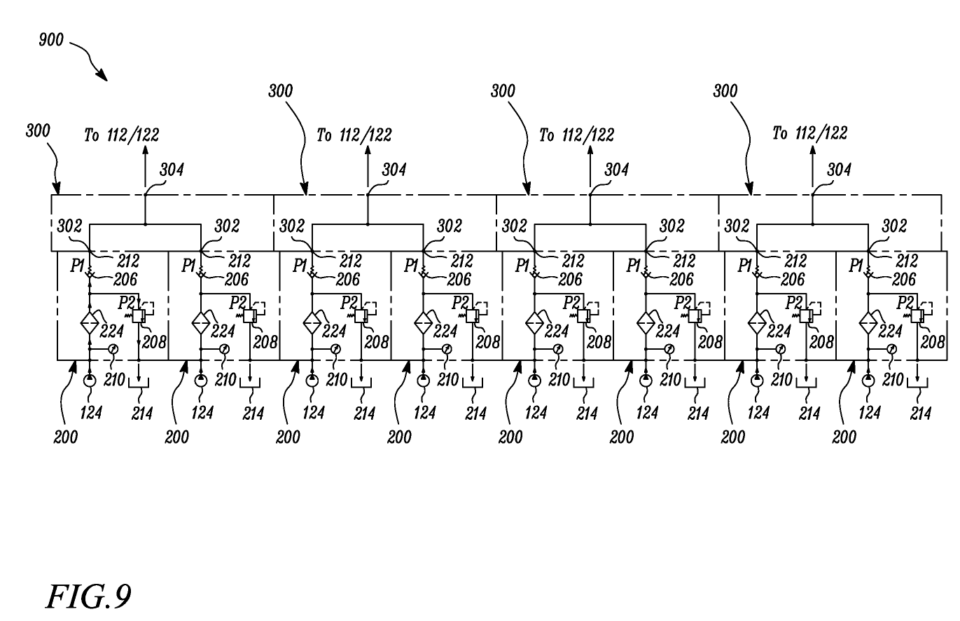

In cases of a machine having several pumps 124 for actuation of the tracks 110 and the bucket 102, multiple filter modules 200 could be beneficially used such that at least one filter module 200 is configured to couple with at least one pump 124 i.e., either a R.H pump 124 or a L.H pump 124 of the machine 100. For example, each of the combination manifolds 500, 600, 700, 800, 900, 1000, and 1100 that are disclosed in FIGS. 5-11 have two, four, six, two, eight, four, and eight filter modules 200 respectively to correspond and couple with two, four, six, two, eight, four, and eight pumps 124 of the machine 100 respectively. Some or all of the pumps 124 from the two, four, six, two, eight, four, and eight pumps 124 disclosed in FIGS. 5-11 respectively may be R.H. pumps 124a or L.H pumps 124b. For example, of the eight pumps 124 shown in FIG. 9, four pumps 124 may be L.H pumps 124b while the other four pumps 124 may be R.H pumps 124a. However, it may be understood that the number of filter modules 200 used in a machine 100 may be beneficially selected to correspond with the number of pumps 124 present in the machine 100, regardless of whether the pumps 124 are L.H. pumps 124b or R.H. pumps 124a.

Referring to FIGS. 2 and 5-11, the filter module 200 is configured to include a first inlet port 202, a filter element 204, a check valve 206, and a relief valve 208. Optionally or additionally, the filter module 200 may also include a pressure gauge 210 located between the first inlet port 202 and the filter element 204. The pressure gauge 210 may be embodied in any form commonly known to one skilled in the art for measuring a pressure of the fluid between the first inlet port 202 and the filter element 204. However, it may be noted that the pressure gauge 210 is merely exemplary in nature, and hence non-limiting of this disclosure. One of ordinary skill in the art will appreciate that embodiments of the present disclosure can be equally implemented in the absence of the pressure gauge 210.

The first inlet port 202 is fluidly coupled to a pump 124 of the machine 100. The filter element 204 is disposed in fluid communication with the first inlet port 202. The check valve 206 is disposed in fluid communication with the filter element 204. The check valve 206 may be embodied in the form of for e.g., a spring-loaded check valve 206. The check valve 206, disclosed herein, is configured to open at a first pressure value P1 such that the first inlet port 202 is allowed to be in fluid communication with a first outlet port 212 of the filter module 200. The relief valve 208 is fluidly coupled to the filter element 204 and disposed parallel to the check valve 206. The relief valve 208 is configured to open at a second pressure value P2 that is greater than the first pressure value P1. For example, if the check valve 206 is set to open at a first pressure value P1 of 50 bar, the relief valve 208 may be configured to open at a second pressure value P2 of 51 bar. Therefore, if the pressure of the fluid between the pump 124 and the check valve 206 exceeds the second pressure value P2, then the relief valve 208 may open to bleed off or vent any excess pressure of the fluid from the filter module 200. The excess pressure of the fluid that returns from between the pump 124 and the check valve 206 may be bled off by routing the excess pressure fluid via the relief valve 208 into a fluid sump 214 of the machine 100. Alternatively, it can be beneficially contemplated to allow this excess pressure fluid to re-enter the filter module 200 via the first inlet port 202 when a pressure of the fluid between the check valve 206 and the pump 124 is insufficient to actuate the check valve 206 into an open position. In this manner, a pressure of the fluid between the pump 124 and the check valve 206 can be regulated before the fluid is allowed to exit the check valve 206 and subsequently, leave the first outlet port 212.

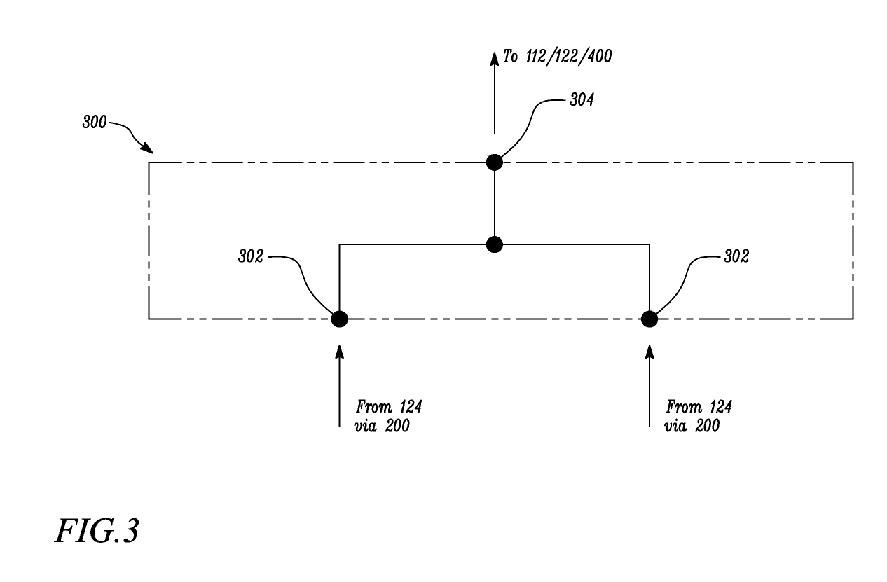

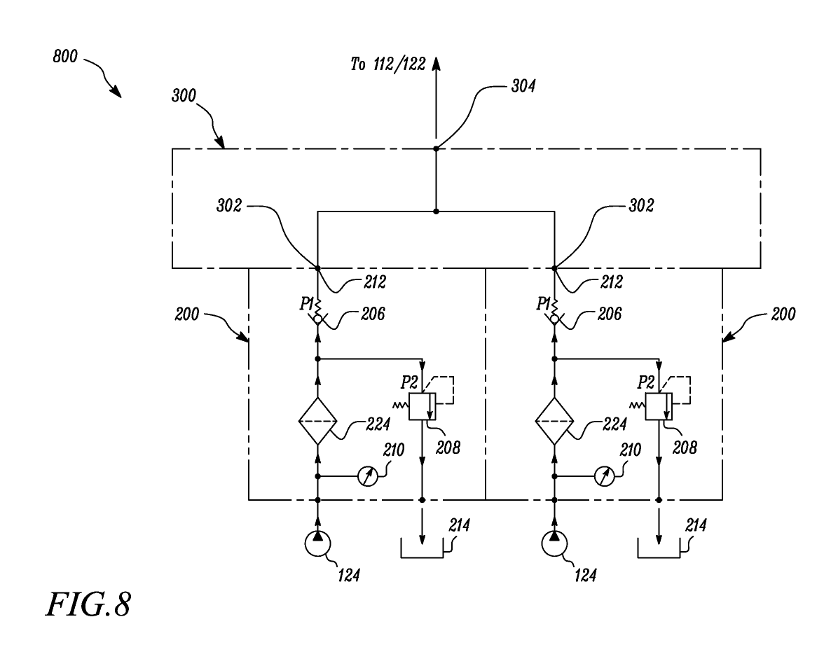

In some embodiments as shown in FIGS. 8-11, the combination manifold 800, 900, 1000, and 1100 is selectively configured to further include at least one junction module 300 of the type and configuration disclosed in FIG. 3. Referring to FIGS. 2, 3, and 8-11; each junction module 300 is configured to couple with at least a pair of adjacently located filter modules 200 on the basis of the machine 100 having multiple pumps 124 therein and correspondingly employing multiple filter modules 200 to couple with the pumps 124. For example, referring to FIG. 8, a pair of filter modules 200 is employed to couple with the pair of pumps 124 from the machine 100. Accordingly, one junction module 300 is provided to couple with the pair of adjacently located filter modules 200 in the illustrated embodiment of FIG. 8. In another example as shown in FIG. 9, eight filter modules 200 are employed to correspond and couple with eight pumps 124 of the machine 100. Accordingly, four junction modules 300 are provided such that each junction module 300 is configured to couple with a pair of adjacently located filter modules 200 in the illustrated embodiment of FIG. 8.

With continued reference to FIGS. 2-3 and 8-11, each junction module 300 includes a pair of second inlet ports 302. Each of the second inlet ports 302 is selectively coupled to the first outlet port 212 of at least one filter module 200 from the pair of adjacently located filter modules 200. Each junction module 300 further includes a second outlet port 304 that is configured to fluidly communicate with the pair of second inlet ports 302. The second outlet port 304 of a given junction module 300 can be coupled with any one of the hydraulic circuits 112 or 122 of the machine 100.

Although, a ratio of a number of second inlet ports 302 to a number of second outlet ports 304 in each of the junction modules 300 from FIGS. 3 and 8-11 is 2:1, this ratio may be changed to include any number of second inlet ports 302 for e.g., 3:1, 4:1, 5:1, and the like depending on specific requirements of an application. This way, each junction module 300 can optionally couple with more than just two adjacently located filter modules 200, for example, three, four, or five filter modules 200 and so on depending on the number of second inlet ports 302 present in the junction module 300.

In various embodiments of the present disclosure, the junction module 300 is configured to combine a supply of fluid that is received individually from various pumps 124 of the machine 100. In cases where the pumps 124 of the machine 100 are classified into R.H. pumps 124a and L.H pumps 124b, the junction module 300 can beneficially combine a supply of pressurized fluid that is received from at least one R.H. pump 124a and at least one L.H pump 124 of the machine 100.

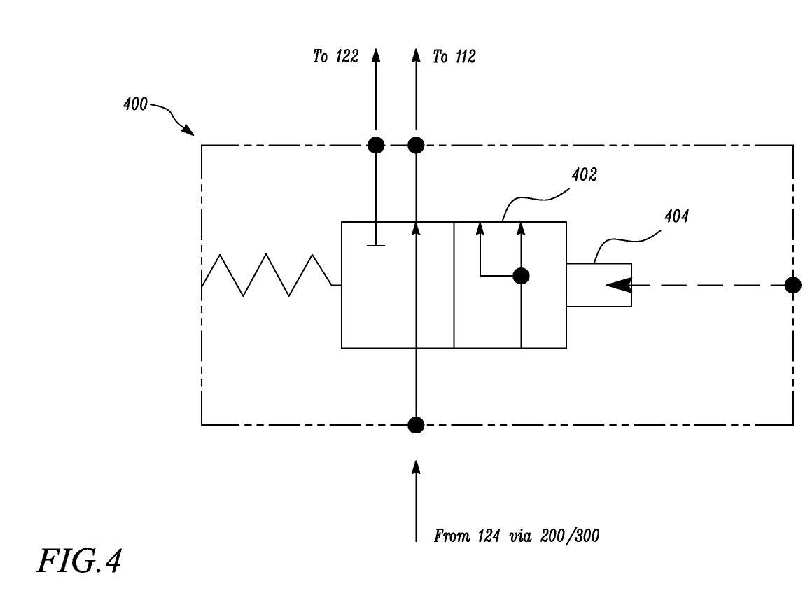

In some embodiments as shown in FIGS. 10-11, the combination manifolds 1000 and 1100 are selectively configured to further include at least one valve module 400 of the type and configuration disclosed in FIG. 4. Referring to FIGS. 2-4 and 10-11, each of the valve modules 400 is selectively coupled to the junction module 300 on the basis of the machine 100 having at least a pair of hydraulic circuits i.e., 112 and 122 therein. Therefore, the valve module 400 is employed if a given type of machine has more than one hydraulic circuit for e.g., the first hydraulic circuit 112 i.e., drive circuit 112, and the second hydraulic circuit 122 i.e., work attachment circuit 122. Therefore, each of the combination manifolds 1000 and 1100 from FIGS. 10-11 may be suitably implemented to selectively power one or both of the first and second hydraulic circuits 112, 122. For instance, the combination manifold 1000 of FIG. 10 could preferably be used when the machine 100 of FIG. 1 includes four pumps 124 that are to be disposed in fluid communication with at least two hydraulic circuits for e.g., the first and second hydraulic circuits 112, 122 of the machine 100. The combination manifold 1100 of FIG. 11 could be preferably used when the machine 100 of FIG. 1 includes eight pumps 124 (shown in FIG. 11) that are to be disposed in fluid communication with the at least two hydraulic circuits of the machine 100 i.e., the first and second hydraulic circuits 112, 122 of the machine 100.

With continued reference to FIGS. 2-4 and 10-11, each valve module 400 includes a valve element 402 therein. In an embodiment as shown in FIGS. 2-4 and 10-11, the valve element 402 may be embodied in the form of a spool-type shuttle valve. However, one skilled in the art can optionally contemplate other types of valve structures to perform functions that are consistent with that of the valve element 402 disclosed herein. As shown in FIGS. 10-11, the valve element 402 is configured to selectively supply the pressurized fluid from the second outlet port 304 of the junction module 300 to the second hydraulic circuit 122 of the machine 100 in a first mode of operation; and to each of the first and second hydraulic circuits 112, 122 in a second mode of operation. As such, a configuration of the valve element 402 depicted in FIGS. 4 and 10-11 is that of a 3-way 2-position valve.

In an embodiment of the present disclosure, the valve element 402 may be configured to supply the pressurized fluid from the second outlet port 304 of the junction module 300 to each of the first and second hydraulic circuits 112, 122 in response to a pilot pressure being applied to the valve element 402 i.e., the second mode of operation may be implemented in the valve element 402 by applying the pilot pressure at a control element 404 associated with the valve element 402. This pilot pressure may be applied manually i.e., by an operator of the machine 100 using suitable linkages, levers and/or other components known to one skilled in the art; or by electromechanical devices such as, but not limited to, solenoids operating under or following a pre-determined flow logic depending on specific requirements of an application.

Although a 3-way 2-position valve is disclosed herein, it may be noted that the 3-way 2-position valve is merely used to couple with the three fluid lines (i.e., one supply and two output lines) and comply with a flow logic that governs the manner of fluid supply to the two hydraulic circuits 112, 122 of the machine 100 when executing functions that are required by the machine 100 on the work site. One of ordinary skill in the art will acknowledge that in other embodiments, other configurations of valve structures may be used in lieu of the 3-way 2-position valve depending on the number of hydraulic circuits present in the machine 100 and a flow logic to be followed (as dictated by specific requirements of an application). For example, in a case where the machine 100 has three or more hydraulic circuits, pressurized fluid may be supplied, in compliance with pre-determined flow logic, to each of the three or more hydraulic circuits using a 3-way 3-position valve, a 4-way 2-position valve, a 4-way 3-position valve, and the like. Therefore, it will be appreciated by persons skilled in the art that any configuration and/or type of valve structure known in the art may be used to form the valve element 402 of the present disclosure depending on factors such as, but not limited to, the number of supply line corresponding with the number of second outlet ports 304 from the junction module 300, the number of hydraulic circuits in the machine 100, the flow logic to be followed for each circuit of the machine 100, and other specific requirements of an application.

A manner of working for the embodiments of the combination manifold 500, 600, and 700 from FIGS. 5-7 will be discussed hereinafter. It is hereby contemplated that the configurations of the combination manifold 500, 600, and 700 depicted in FIGS. 5-7 could be suitably implemented when pressurized fluid from various pumps 124 in the machine 100 is to be supplied to at least one hydraulic circuit of the machine 100. For example, any of the combination manifolds 500, 600, and 700 from FIGS. 5-7 could be used for supplying pressurized fluid to either one of the first hydraulic circuit 112 and the second hydraulic circuit 122. If any configuration of combination manifold 500, 600, and 700 from FIGS. 5-7 is used in conjunction with the first hydraulic circuit 112 alone, then a rotation of the tracks 110 relative to the carbody 109 could be accomplished for bringing about a movement of the machine 100 on the ground surface 114. If any configuration of combination manifold 500, 600, and 700 from FIGS. 5-7 is used in conjunction with the second hydraulic circuit 122 alone, then an articulation of the boom 116, the stick 118, and the bucket 102 could be accomplished for bringing about a movement of the bucket 102 relative to the frame 108.

During operation, configurations of the combination manifolds 500, 600, and 700 from FIGS. 5-7 can allow pressurized fluid from the respective pumps 124 i.e., R.H pump 124a or L.H pump 124b of the machine 100 to enter the filter modules 200 via respective first inlet ports 202. Thereafter, the pressurized fluid may be subject to filtration at filter elements 204 present in the respective filter modules 200. If a pressure of the fluid from one or more pumps 124 is sufficient to overcome a bias offered by the respective check valve 206 i.e. the pressure of fluid exceeds the first pressure value P1 setting of the respective check valve 206, then the pressurized fluid can actuate the respective check valve 206 to open. This way, the respective first inlet port 202 can be selectively disposed in fluid communication with its respective first outlet port 212 and hence, allow the pressurized fluid to exit the respective filter module 200 via its respective first outlet port 212.

However, if a pressure of the fluid from one or more pumps 124 is in excess of the first pressure value P1 so as to exceed even the second pressure value P2 setting of the relief valve 208, the pressurized fluid from that filter module 200 may actuate the respective relief valve 208 to open and bleed off excess pressure from the fluid present between the respective pump 124 and the respective check valve 206. This way, each filter module 200 of the combination manifold 500, 600, and 700 can filter the pressurized fluid besides regulating a pressure of the fluid being supplied from a given pump 124 of the machine 100 to an associated hydraulic circuit i.e., the first hydraulic circuit 112 or the second hydraulic circuit 122.

Although it disclosed herein that each filter module 200 of the combination manifold 500, 600, and 700 can supply pressurized fluid to an associated hydraulic circuit i.e., the first hydraulic circuit 112 alone, or the second hydraulic circuit 122 alone, it may be possible to optionally couple at least one filter module 200 from any of these combination manifolds i.e., 500, 600, or 700 with the first hydraulic circuit 112 and at least one other filter module 200 from the same combination manifold i.e., 500, 600, or 700 with the second hydraulic circuit 122 of the machine 100. By coupling at least one filter module 200 from any of these combination manifolds i.e., 500, 600, or 700 with the first hydraulic circuit 112 and at least one other filter module 200 from the same combination manifold i.e., 500, 600, or 700 with the second hydraulic circuit 122; pressurized fluid from respective pumps 124 can be supplied to both the hydraulic circuits i.e., 112 and 122 of the machine 100 using a single combination manifold i.e., 500, 600, or 700. This way, one of skill in the art can beneficially contemplate to use any one of these combination manifolds 500, 600, or 700 for accomplishing a rotation of the tracks 110 relative to the carbody 109 as well as bringing about a movement of the bucket 102 relative to the frame 108.

A manner of working for the embodiments of the combination manifolds 800 and 900 from FIGS. 8 and 9 respectively will be discussed hereinafter. It is hereby contemplated that the configurations of the combination manifolds 800 and 900 depicted in FIGS. 8 and 9 could be suitably implemented when pressurized fluid from various pumps 124 in the machine 100 is to be supplied to one hydraulic circuit 112/122 of the machine 100. For example, any of the combination manifolds 800/900 from FIGS. 8 and 9 could be used for supplying pressurized fluid to either one of the first hydraulic circuit 112 or the second hydraulic circuit 122. If any one of the configurations of combination manifolds 800/900 from FIGS. 8 and 9 is used with the first hydraulic circuit 112 of the machine 100, then the respective combination manifold 800/900 can facilitate a rotation of the tracks 110 relative to the carbody 109 so as to bring about a movement of the machine 100 on the ground surface 114. However, if any one of the configurations of the combination manifolds 800/900 from FIGS. 8 and 9 is used for the second hydraulic circuit 122, then the respective combination manifold 800/900 can facilitate an articulation of the boom 116, the stick 118, and the bucket 102 to execute a movement of the bucket 102 relative to the frame 108.

With regards to operation, the filter modules 200 of the combination manifolds 800 and 900 from FIGS. 8-9 operate in a manner similar to that of the filter modules 200 from the combination manifolds 500, 600, and 700 disclosed in FIGS. 5-7. For purposes of brevity in this document, re-capitulation in the explanation pertaining to a working of the filter modules 200 has been avoided herein.

As one or more junction modules 300 are present in the combination manifolds 800 and 900 of FIGS. 8 and 9, these junction modules 300 can beneficially combine a supply of the pressurized fluid from two pumps 124 of the machine 100 when the pressurized fluid from each pump 124 leaves the first outlet port 212 of the respective filter modules 200. As such, each junction module 300, as shown in FIGS. 8 and 9, is configured to couple with a pair of adjacently located filter modules 200, and hence, allow for a mixing or combining a flow of the pressurized fluid from the pair of adjacently located filter modules 200.

Although it has been disclosed herein that each junction module 300 is configured to couple with a pair of filter modules 200, and subsequently combine a supply of the pressurized fluid from the pair of filter modules 200, in alternative embodiments of the present disclosure, the junction module 300 can be configured to combine a supply of the pressurized fluid from any number of filter modules 200. One of ordinary skill in the art can contemplate to beneficially provide more than two second inlet ports 302 in each junction module 300 so that the junction modules 300 can couple with more than two filter modules 200 and hence, combine a flow of pressurized fluid from more than two filter modules 200. For example, each junction module 300 may be configured to define or include four second inlet ports 302 therein thus allowing each of the junction modules 300 to be able to couple with four distinct filter modules 200 in the combination manifolds 800/900. Therefore, it may be noted that a number of second inlet ports 302 disclosed in each junction module 300 is merely exemplary in nature and hence, non-limiting of this disclosure. Any number of second inlet ports 302 may be provided in each junction module 300 of the present disclosure without deviating from the spirit of the present disclosure.

Although it disclosed herein that the junction modules 300 of the combination manifold 900 can supply pressurized fluid to an associated hydraulic circuit i.e., the first hydraulic circuit 112 alone, or the second hydraulic circuit 122 alone, it can be contemplated to optionally couple at least one junction module 300 from the combination manifold 900 with the first hydraulic circuit 112 and at least one other junction module 300 from the same combination manifold 900 with the second hydraulic circuit 122 of the machine 100. By coupling at least one junction module 300 of the combination manifold 900 with the first hydraulic circuit 112 and at least one other junction module 300 from the same combination manifold 900 with the second hydraulic circuit 122; pressurized fluid from respective pumps 124 can be supplied to both the hydraulic circuits i.e., 112 and 122 of the machine 100 using a single combination manifold i.e., 900. This way, one skilled in the art can beneficially contemplate to use a single combination manifold 900 for accomplishing a rotation of the tracks 110 relative to the carbody 109 as well as bringing about a movement of the bucket 102 relative to the frame 108.

A manner of working for the embodiments of the combination manifolds 1000 and 1100 from FIGS. 10 and 11 will be discussed hereinafter. It is hereby contemplated that the configurations of the combination manifolds 1000 and 1100 depicted in FIGS. 10 and 11 could be suitably implemented when pressurized fluid from various pumps 124 in the machine 100 is to be selectively supplied to one or more hydraulic circuits of the machine 100. For example, either one of the combination manifolds 1000 and 1100 from FIGS. 10 and 11 could be used for selectively supplying pressurized fluid to one or both of the first hydraulic circuit 112 and the second hydraulic circuit 122 present in the machine 100 of FIG. 1. Therefore, if any one configuration of the combination manifold 1000/1100 from FIGS. 10 and 11 is used in the machine 100, the respective combination manifold 1000/1100 can be configured to supply pressurized fluid from the pumps 124 of the machine 100 to each of the first and second hydraulic circuits 112, 122, or the second hydraulic circuit 122 alone.

With regards to operation, the filter modules 200 and the junction modules 300 from the combination manifolds 1000 and 1100 of FIGS. 10 and 11 operate in a manner similar to that of the filter modules 200 and junction modules 300 from the combination manifolds 800 and 900 of FIGS. 8 and 9. For purposes of brevity in this document, re-capitulation in the explanation pertaining to a working of the filter modules 200 and the junction modules 300 has been avoided herein.

As one or more valve modules 400 are present in the configurations of the combination manifolds 1000 and 1100 from FIGS. 10 and 11, these combination manifolds 1000 and 1100 can beneficially allow the operator to choose if the pressurized fluid should be used for driving the second hydraulic circuit 122 alone i.e., work attachment circuit 122 associated with the bucket 102 of the machine 100, or for driving each of the first and second hydraulic circuits 112, 122 i.e., drive circuit 112 associated with the tracks 110 of the machine 100, and work attachment circuit 122 associated with the bucket 102 of the machine 100. Accordingly, the operator can actuate the valve element 402 present in the respective valve modules 400 into a suitable position or mode of operation such that the pressurized fluid is selectively routed into each of the first and second hydraulic circuits 112, 122, or into the second hydraulic circuit 122 alone.

If the operator actuates all valve elements 402 into the first mode of operation, then the combination manifold 1000/1100 of FIGS. 10 and 11 can drive the second hydraulic circuit 122 alone i.e., the work attachment circuit 122 alone and hence; actuate movement of the bucket 102 relative to the frame 108. If the operator actuates all valve elements 402 into the second mode of operation, then the combination manifold 1000/1100 can drive the first hydraulic circuit 112 together with the second hydraulic circuit 122 i.e., supply the pressurized fluid to the drive circuit 112 associated with the tracks 110, and the work attachment circuit 122 associated with the bucket 102. Hence, by positioning the valve element 402 in the second mode of operation, the operator can actuate a movement of the tracks 110 relative to the carbody 109 in addition to actuating a movement of the bucket 102 relative to the frame 108.

Although it is disclosed herein that when in the first mode of operation, each valve module 400 (from any of the combination manifolds 1000/1100) selectively supplies pressurized fluid to the second hydraulic circuit 122 alone, each of the valve modules 400 can be alternatively configured to supply the pressurized fluid to the first hydraulic circuit 112 alone instead of the second hydraulic circuit 122 alone when the valve modules 400 are in the first mode of operation. Such alternatively configured valve modules 400 can supply the pressurized fluid to each of the first and second hydraulic circuits 112, 122 when in the second mode of operation. Therefore, using these alternately configured valve modules 400, an operator can selectively choose to rotate the tracks 110 alone in the first mode of operation, or accomplish movement of the bucket 102 relative to the frame 108 in addition to rotating the tracks 110 of the machine 100.

Various embodiments disclosed herein are to be taken in the illustrative and explanatory sense, and should in no way be construed as limiting of the present disclosure. All joinder references (e.g., attached, affixed, coupled, engaged, connected, and the like) are only used to aid the reader's understanding of the present disclosure, and may not create limitations, particularly as to the position, orientation, or use of the modules/ devices and/or methods disclosed herein. Such joinder references are to be construed broadly. Moreover, such joinder references can infer that two elements or modules are not directly connected to each other.

Additionally, all numerical terms, such as, but not limited to, “first”, “second”, “third”, or any other ordinary and/or numerical terms, should also be taken only as identifiers, to assist the reader's understanding of the various modules, circuits, elements, embodiments, variations and/ or modifications of the present disclosure, and may not create any limitations, particularly as to the order, or preference, of any module, circuit, element, embodiment, variation and/or modification relative to, or over, another module, circuit, element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

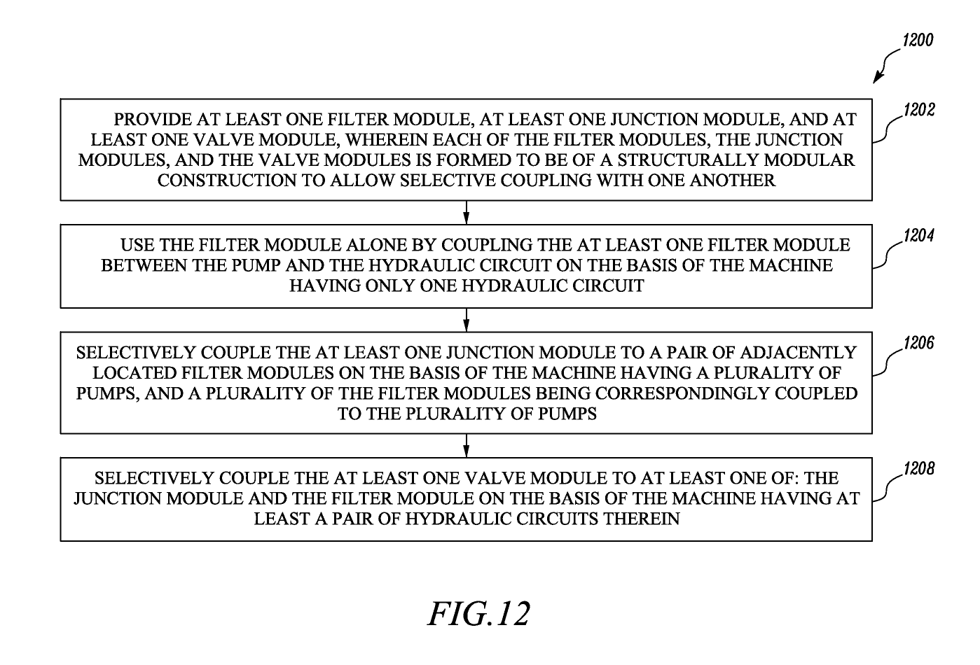

FIG. 12 illustrates a method 1200 of using any one of the combination manifolds 500, 600, 700, 800, 900, 1000, 1100, and 1300, pursuant to various embodiments of the present disclosure. At step 1202, the method 1200 includes providing at least one filter module 200, at least one junction module 300, and at least one valve module 400, wherein each of the filter modules 200, the junction modules 300, and the valve modules 400 is formed to be of a structurally modular construction to allow selective coupling with one another. As disclosed earlier herein, the terms ‘one another’ may also refer to modules 200/300/400 of the same type being coupled together in sequence for e.g., as shown in FIGS. 5-7, where multiple filter modules 200 are being coupled in a sequential manner, or for e.g., as shown in FIG. 9, where multiple junction modules 300 are coupled in a sequential manner.

At step 1204, the method 1200 further includes using the filter module 200 alone by coupling the at least one filter module 200 between the pump 124 and the hydraulic circuit i.e., either one of the first hydraulic circuit 112 and the second hydraulic circuit 122, on the basis of the machine 100 having at least any one of the hydraulic circuits i.e., 112 or 122. At step 1206, the method 1200 further includes selectively coupling the at least one junction module 300 to a pair of adjacently located filter modules 200 on the basis of the machine 100 having a plurality of pumps 124, and a plurality of the filter modules 200 being correspondingly coupled to the plurality of pumps 124.

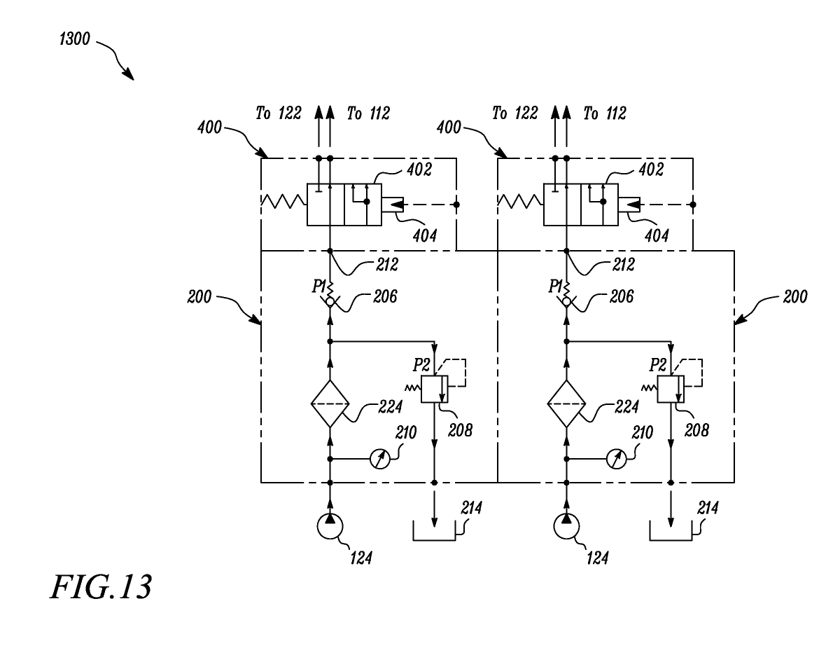

At step 1208, the method 1200 further includes selectively coupling the valve module 400 to at least one of: the junction module 300 and the filter module 200 on the basis of the machine 100 having at least a pair of hydraulic circuits therein. In various embodiments of the present disclosure, although the valve module 400 is coupled to the junction module 300 (See FIGS. 10-11), in an optional embodiment, the valve module 400 may be directly coupled to the filter module 200 (See FIG. 13). Such a configuration of combination manifold 1300 may be beneficially contemplated when a mixing of the pressurized fluid from several pumps 124 of the machine 100 is not required. Such a configuration of the combination manifold 1300 may however, also allow a manufacturer to do away with use of the junction module 300 and may help save associated costs.

Embodiments of the present disclosure have applicability for implementation and use in actuating specific functions of a machine 100 by selectively supplying pressurized fluid to one or more hydraulic circuits of the machine 100. Moreover, embodiments disclosed herein also have applicability for implementation and use in filtering and regulating a pressure of the fluid before selectively supplying the pressurized fluid to one or more hydraulic circuits of the machine 100.

A combination manifold 500, 600, 700, 800, 900, 1000, 1100, and 1300 disclosed in accordance with various embodiments of the present disclosure is configured to include one or more modules 200/300/400 of the same type depending on a number of pumps 124 and a number of hydraulic circuits present in the machine 100. For instance, various configurations of the combination manifolds 500, 600, 700, 800, 900, 1000, 1100, and 1300 disclosed herein include one or more filter modules 200, one or more junction modules 300, and one or more valve modules 400. It may be noted that in embodiments of the present disclosure, each of the filter modules 200, junction modules 300, and valve modules 400 is beneficially configured to be of a structurally modular construction so that the filter modules 200, the junction modules 300, and the valve modules 400 can be selectively coupled with ‘one another’ to form the respective combination manifold 500, 600, 700, 800, 900, 1000, 1100, and 1300. A number and type of module 200/300/400 used in the respective configurations of combination manifolds 500, 600, 700, 800, 900, 1000, 1100, and 1300 may depend on the number of pumps 124, the number of hydraulic circuits, and other specific requirements of an application. The terms ‘one another’ disclosed herein may also refer to modules of the same type i.e., 200/300/400 being coupled together in sequence for e.g., as shown in FIGS. 5-7, where multiple filter modules 200 are being coupled in a sequential manner, or for e.g., as shown in FIG. 9, where multiple junction modules 300 are disposed in a sequential manner.

By designing each of the modules 200, 300, and 400 in a modular manner, a manufacturer can quickly and easily produce a combination manifold 500/600/700/800/900/1000/1100/1300 for a given type of machine by merely inter-fitting or coupling the various modules 200, 300, and/or 400 in a selective manner depending on specific requirements of an application. The manufacturer may produce a combination manifold 500, 600, 700, 800, 900, 1000, 1100, and 1300 using one type of module (See filter module 200 of FIG. 2); many modules of the same type (See filter modules 200 in FIG. 5-7); or different types of modules (See filter modules 200, junction modules 300, and/or valve modules 400 in FIGS. 8-11). As the three distinct modules 200, 300, and 400 each exhibit structural modularity, manufacturers may entail limited costs associated with setting up and running three manufacturing or process lines (corresponding to the three distinct modules 200, 300, and 400), and for subsequently producing numerous possible configurations of combination manifolds, for example, 500, 600, 700, 800, 900, 1000, 1100, and 1300 with the three distinctly and modularly structured modules 200, 300, and 400.

Previously known fluid manifolds were conventionally produced on a ‘built-to-suit’ basis where a unique design of fluid manifold was produced to meet specific requirements of the application. Manufacturers of such previously known fluid manifolds typically incurred increased costs, time, and effort in producing these uniquely configured or ‘built-to-suit’ fluid manifolds. However, with implementation of the embodiments disclosed herein, a manufacturer can offset costs, time, and effort previously incurred in the making and use of conventional fluid manifolds. Moreover, with use of embodiments disclosed herein, a combination manifold 500, 600, 700, 800, 900, 1000, 1100, and 1300 can be versatile in that that the combination manifold 500, 600, 700, 800, 900, 1000, 1100, and 1300 can merely use multiples of a particular module 200/300/400, and thereafter be readily implemented for use across several types of machines. As such, each of the combination manifolds 500, 600, 700, 800, 900, 1000, 1100, and 1300 disclosed herein (see FIGS. 5-11) employs multiples of the filter module 200 from FIG. 2, multiples of the junction module 300 from FIG. 3, and/or multiples of the valve module 400 from FIG. 4.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A combination manifold for selectively driving at least one hydraulic circuit of a machine, the combination manifold comprising:
at least one filter module, wherein the filter module is configured to fluidly connect with at least one pump of the machine;
at least one junction module, wherein each junction module is selectively coupled with at least a pair of adjacently located filter modules on the basis of the machine having a plurality of the pumps and the machine correspondingly employing a plurality of the filter modules; and
at least one valve module, wherein the valve module is selectively coupled to at least one of: the junction module and the filter module on the basis of the machine having at least a pair of hydraulic circuits therein.

2. The combination manifold of claim 1, wherein the filter module, the junction module, and the valve module are each configured to be of a structurally modular construction so as to allow selective coupling with one another.

3. The combination manifold of claim 1, wherein the filter module comprises:
a first inlet port;
a filter element disposed in fluid communication with the first inlet port;
a check valve disposed in fluid communication with the filter element, the check valve configured to open at a first pressure value to allow the inlet port to be in fluid communication with a first outlet port; and
a relief valve fluidly coupled to the filter element and disposed parallel to the check valve, the relief valve configured to open at a second pressure value, the second pressure value being higher than the first pressure value.

4. The combination manifold of claim 1, wherein the junction module comprises:
at least a pair of second inlet ports, wherein each second inlet port is selectively coupled to the first outlet port of at least one filter module from the pair of adjacently located filter modules; and
a second outlet port configured to fluidly communicate with each of the second inlet ports.

5. The combination manifold of claim 4 further comprising a valve module selectively coupled to at least one of: the junction module and the filter module on the basis of the machine having at least a pair of hydraulic circuits therein.

6. The combination manifold of claim 5, wherein the valve module comprises a valve element therein.

7. The combination manifold of claim 5, wherein the valve element is a spool-type shuttle valve.

8. The combination manifold of claim 5, wherein the valve element is configured to selectively supply a flow of fluid from the second outlet port to:
a second hydraulic circuit of the machine in a first mode of operation; and
a first hydraulic circuit in addition to the second hydraulic circuit of the machine in a second mode of operation.

9. The combination manifold of claim 8, wherein the valve element is configured to supply the flow of fluid from the second outlet port to the first hydraulic circuit and the second hydraulic circuit of the machine in response to a pilot pressure being applied to the valve element.

10. A combination manifold for selectively driving at least one hydraulic circuit in a machine, the combination manifold comprising:
a filter module comprising:
a first inlet port;
a filter element disposed in fluid communication with the first inlet port;
a check valve disposed in fluid communication with the filter element, the check valve configured to open at a first pressure value to allow the first inlet port to be in fluid communication with a first outlet port; and
a relief valve fluidly coupled to the filter element and disposed parallel to the check valve, the relief valve configured to open at a second pressure value, the second pressure value being greater than the first pressure value.

11. The combination manifold of claim 10 further comprising a plurality of the filter modules on the basis of the machine having a plurality of pumps.

12. The combination manifold of claim 11, wherein each filter module from the plurality of filter modules is configured to fluidly connect with at least one pump of the machine.

13. The combination manifold of claim 11 further comprising a plurality of junction modules, wherein each junction module is selectively coupled to at least a pair of adjacently located filter modules, each of the junction modules comprising:
at least a pair of second inlet ports, wherein each second inlet port is selectively coupled to the first outlet port from at least one filter module; and
a second outlet port configured to fluidly communicate with each of the second inlet ports.

14. The combination manifold of claim 13 further comprising a valve module selectively coupled to at least one of: the junction module and the filter module on the basis of the machine having at least a pair of hydraulic circuits therein.

15. The combination manifold of claim 14, wherein the filter module, the junction module, and the valve module are each configured to be of a structurally modular construction so as to allow selective coupling with one another.

16. The combination manifold of claim 14, wherein the valve module comprises a valve element therein.

17. The combination manifold of claim 14, wherein the valve element is a spool-type shuttle valve.

18. The combination manifold of claim 14, wherein the valve element is configured to selectively supply a flow of fluid from the second outlet port to:
a second hydraulic circuit of the machine in a first mode of operation; and
a first hydraulic circuit in addition to the second hydraulic circuit of the machine in a second mode of operation.

19. The combination manifold of claim 18, wherein the valve element is configured to supply the flow of fluid from the second outlet port to the first hydraulic circuit and the second hydraulic circuit of the machine in response to a pilot pressure being applied to the valve element.

20. A method of using a combination manifold for a machine having at least one pump and at least one hydraulic circuit therein, the method comprising:
providing at least one filter module, at least one junction module, and at least one valve module, wherein each of the filter modules, the junction modules, and the valve modules is formed to be of a structurally modular construction to allow selective coupling with one another;
using the filter module alone by coupling the at least one filter module between the pump and the hydraulic circuit on the basis of the machine having only one hydraulic circuit;
selectively coupling the at least one junction module to a pair of adjacently located filter modules on the basis of the machine having a plurality of pumps, and a plurality of the filter modules being correspondingly coupled to the plurality of pumps; and
selectively coupling the at least one valve module to at least one of: the junction module and the filter module on the basis of the machine having at least a pair of hydraulic circuits therein.
